(19) United States
(12) Patent Application Publication
(10) Pub. No.: US 2011/0108060 A1
(43) Pub. Date: May 12, 2011

(54) Golf towel with dry and wet section

(76) Inventor: Sung Kuk, Los Angeles, CA (US)

(21) Appl. No.: 12/006,382

(22) Filed: Jan. 2, 2008

(51) Int. Cl. B08B 7/00

(52) U.S. Cl. 134/6

(57) ABSTRACT

A golf towel and various methods of folding the towel for cleaning off golf balls are disclosed. The golf towel comprises two layers joined together to form an upper portion and a lower portion thereof. The upper wet section is separated from the lower dry section by a thick border and a water impervious layer that retains water content inside the wet section for relatively long duration. The invention includes various methods of folding the towel, preferably the wet section of the towel in a single triangular, a double triangular, or a square shape thereby forming a pocket like structure. The golf ball to be io cleaned is placed in the pocket like structure of the first section of the towel hung by means of a thread. The moisture content is completely removed by cleaning the ball using the dry section of the towel.

### CROSS-REFERENCE TO RELATED APPLICATIONS

Not Applicable.

### STATEMENT REGARDING FEDERALLY SPONSORED RESEARCH AND DEVELOPMENT

Not Applicable.

### FIELD OF THE INVENTION

This invention relates to golf towels, and more particularly to various methods of folding a golf towel to form at least one water retaining pocket like structure for effectively cleaning golf balls and related golf accessories.

### DISCUSSION OF RELATED ART

Golf is a sport that continues to increase in popularity. While playing the game, a golfer will typically encounter residual dirt, grass and other material on the golf ball, club faces and/or his hands as he traverses the golf course. Golfers often spend time on the golf course when the weather or playing conditions may not be ideal for the game, like on a hot, humid day, or in the early morning when there is still dew on the ground, or even on a rainy day when the grass and ground are still wet. These are the times when a golf towel becomes a necessity for wiping your hands or for cleaning the golf club heads, golf balls, or golf handles from perspiration, dampness, dirt and grass.

In an effort to maintain the clubs and balls in top rate, clean condition, a golfer will typically carry one or more golf towels either, attached to his belt or to a carabineer on his golf bag. Often, some golfers periodically desire to moisten the towel at a water cooler on the course or in a body of water traversing one or more holes at the course. This occasionally may be a distracting side trip during the round. Once the ball lands on the green the golfer has to mark the spot before taking the ball from the fairway or rough to clean the ball. Some prior art golf towels include a dry, clean surface and a wet, moistened surface for cleaning the golf balls in both dry and wet conditions. Other golf towels may include a pocket which may be configured to contain moisture, with the outside of the towel having a dry cleaning surface for wiping down the club face or ball. These towels dry quickly and the golfers need to get out of the course to wet their golf towels, breaking the rhythm of the game.

Some other towel structures described in prior art utilize an outer layer of towel material first having an absorbency, to substantially encompass an inner layer of wiping material second having a predetermined absorbency, where the inner layer of wiping material is separated from the outer layer of towel material by an impervious film layer that substantially inhibits the transfer of water from the towel material to the wiping material. This structure allows sports equipment or other implements to be wiped free of dirt and water by the outer layer of towel material and to then be wiped dry by the inner layer of wiping material. The towel structure is such that the outer layer of towel material can be readily removed for cleaning and drying.

One known type of golf towel includes a split clamp affixed to the towel. This split clamp is attached to a D-ring metal loop included on traditional golf bags. The main problem with this system is that the split clamp is difficult to secure and detach requiring one hand to hold the metal loop and the other hand to engage the split clamp. This makes this design inconvenient when the need arises to detach the towel for use on the fairway or putting green. A multi-purpose golf club head and ball washer arrangement is illustrated having a cover for protecting the head of a golf club, and an associated housing, capable of use in washing and drying golf balls. Multiple types of fabrics are utilized along with a moisture barrier to assure that water and detergent within the ball washing compartment is kept from the golf club head compartment. The structure described has little general application to towel structures and is of little value to dry or clean any object other than is golf balls.

One prior art include a golf ball cleaner in a shape of a pocket comprised of a water absorbing inside layer, and a waterproof outer layer. Water remains in the pocket for a long time. To clean golf ball the player should open the mouth of the pocket and insert the ball into the pocket. User has to turn over the pocket to remove dirt remaining inside and has to do laundry and drying for the next play. Another golf towel is illustrated having a first dry cleaning surface and a second moisturized cleaning element in a pocket. The pocket is partially open and a non-permeable polyethylene film blocks the water in moisturized element from permeating to the first dry layer. The golf ball should be inserted into this pocket to get cleaned.

Therefore, there is a need for a single golf towel that can perform the function of drying the ball as well as making the ball wet according to the playing conditions. Further, the towel must be capable of retaining the water content for longer duration of time during the play. Also different methods of folding the golf towel can add additional benefits of using the towel in different situations thereby providing a better visual appearance for the golf towel. The present invention accomplishes these objectives.

### SUMMARY OF THE INVENTION

The present invention is a golf towel and various methods of folding the golf towel to enhance cleaning of golf balls with the towel remaining wet on one portion and dry on is the other portion. The golf towel comprises two layers and the layers of the towel are joined together to form an upper section and a lower section for effective cleaning off golf balls. A water impervious layer is provided in the front side of the upper section that facilitates to retain water content in the towel for relatively long duration. The wet section and the dry section are discriminated from each other by a thick border and the water impervious layer attached to the wet section.

The present invention includes various methods of folding the golf towel thereby forming a pocket like structure on at least one section of the towel. Preferably, the wet section of the towel is folded in at least one method such as a single triangular, a double triangular, or a square shape to form at least one pocket like structure. The golf ball to be cleaned is placed in the pocket like structure and the ball is cleaned by water adhered inside the pocket like structure of the towel. The ball is taken out of the wet section and the moisture content is completely removed from the ball by wiping the ball with the dry section of the golf towel. A number of holes fabricated on different corners and the thread attached to one corner of the towel passes through all the holes facilitates hanging the folded towel.

Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1A-1E shows a golf towel and the different steps involved in the single triangle type folding method of the golf towel;

FIG. 2A-2F shows a golf towel and the different steps involved in the double triangle type folding method of the golf towel;

FIG. 3A-3F shows a golf towel and the different steps involved in the square type folding method of the golf towel;

FIG. 4A-4C shows the various steps of using the golf towel for cleaning golf balls.

### DETAILED DESCRIPTION OF THE PREFERRED EMBODIMENT

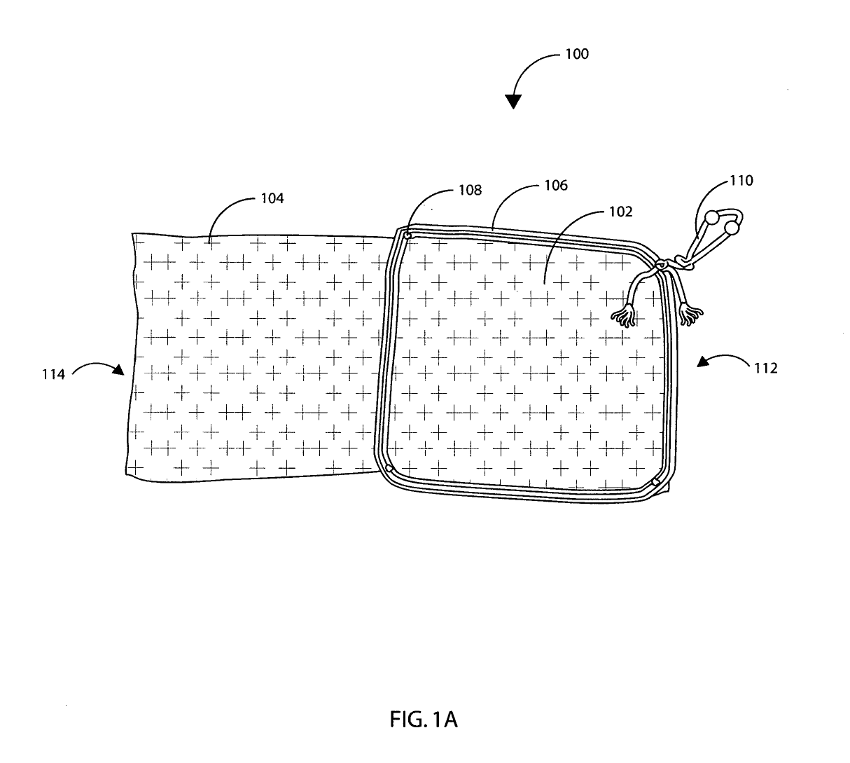

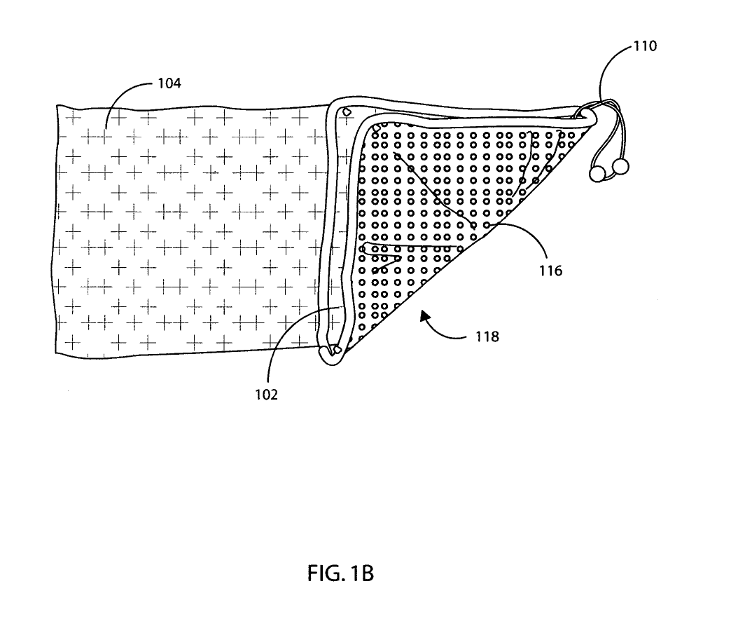

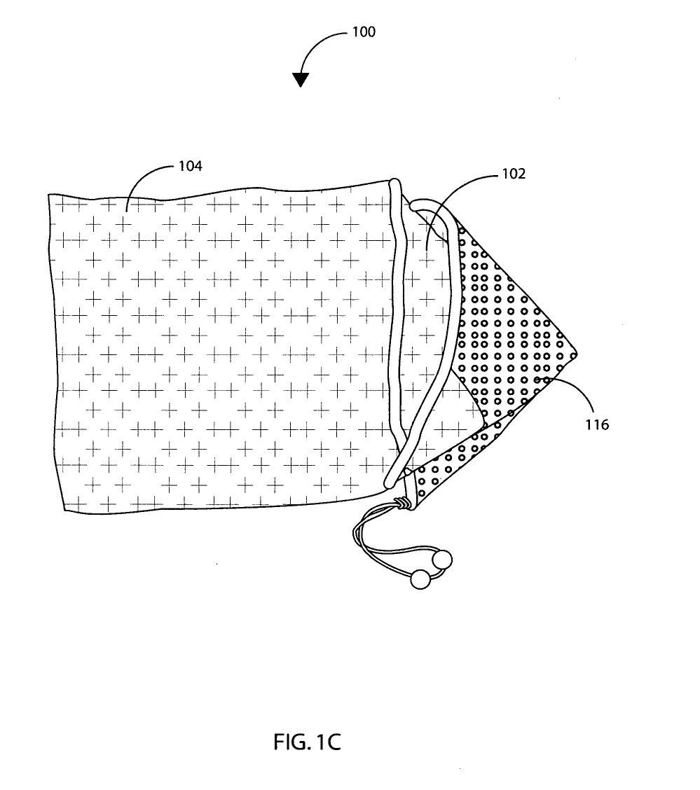

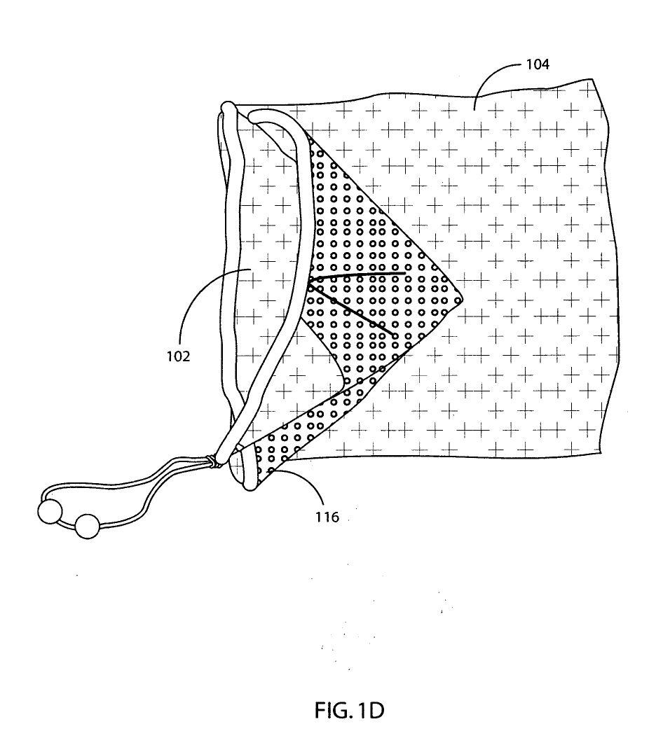

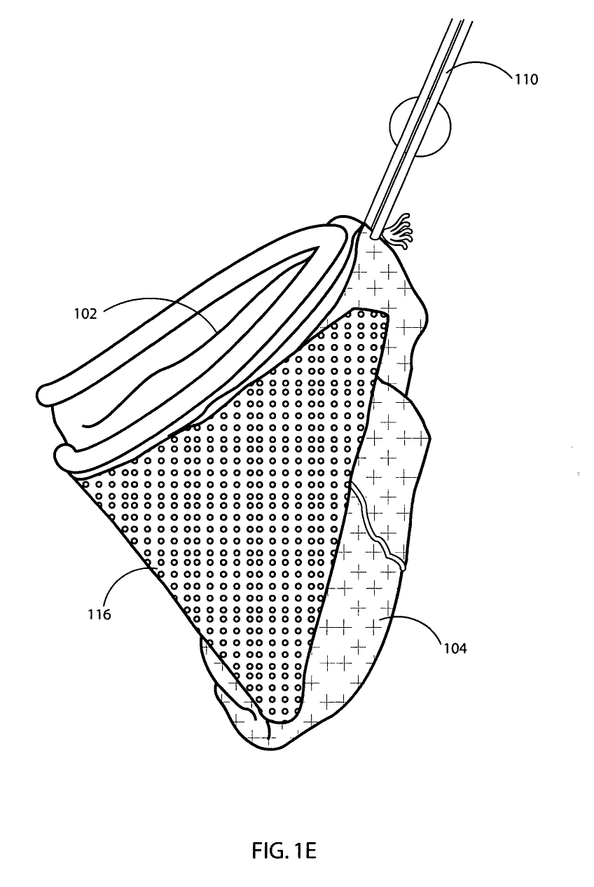

FIG. 1A-1E illustrates a golf towel 100 and the different steps involved in the single io triangle type folding method of the golf towel 100. The wet section 102 is discriminated from the dry section 104 by a thick border 106 and a water impervious layer 116 attached to the wet section 102. The water impervious layer 116 in the front side of the wet section 102 helps to retain the water content in the towel 100.

The holes 108 and the thread 110 on the corner of the towel 100 serve to secure the towel 100 folded together. In FIG. lA the towel 100 is first placed with the back side facing up with the wet section 102 on top side 112 and the dry section 114 at the bottom side 114. The wet section 102 is folded diagonally inwards thereby forming a triangular shape 118 for the wet section 102 of the towel 100 as shown in FIG. 1B. The triangular section 118 is then folded backwards from the middle of it thereby forming a triangular shaped upper section 120 as shown in FIG. 1C. As in FIG. 1D, the towel is folded from the joining of the wet and dry sections 102 and 104 thereby providing the front side view of the dry section 104 of the towel 100. The micro-fiber layered wet section 102 is on top of the dry section 104 of the towel 100. The micro-fiber may be a combination of blends of polyester and polyamide. The golf towel 100 is again folded through its center axis to form the desired triangular shape 118 and then hanged up by means of the thread 110 attached to one corner as shown in FIG. 1E. In alternative embodiments, the micro-fiber layer wet section 102 may be composed of cotton or other anti-bacterial fabrics or materials to prevent excessive odor.

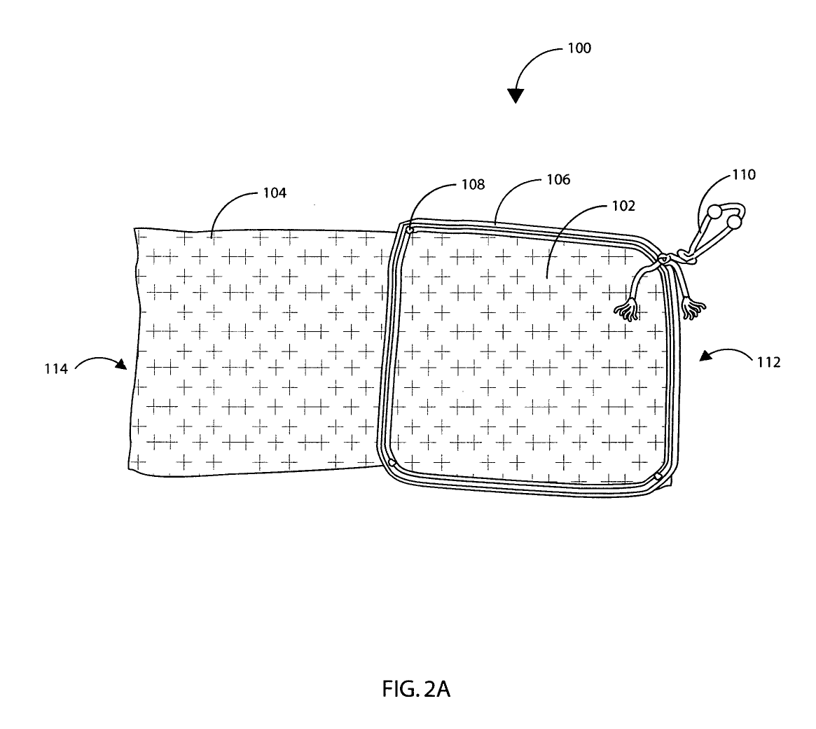

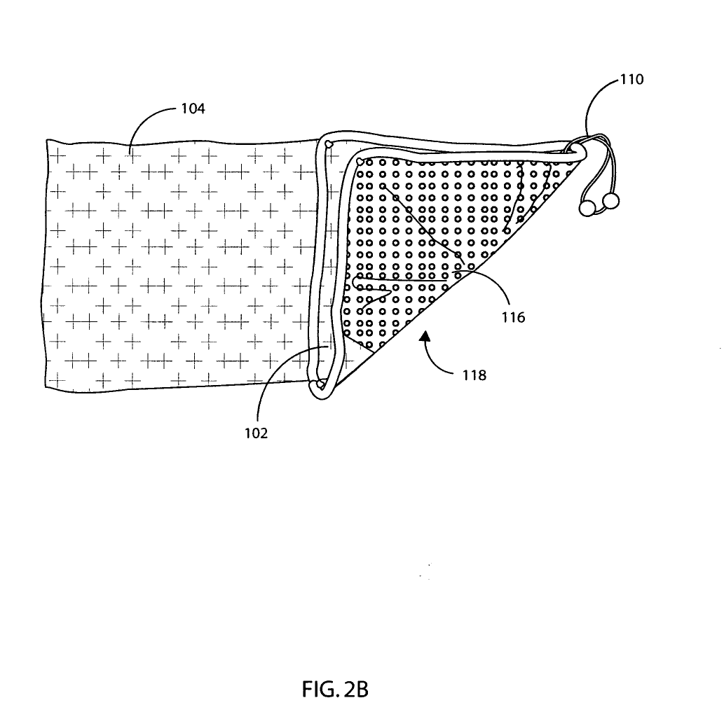

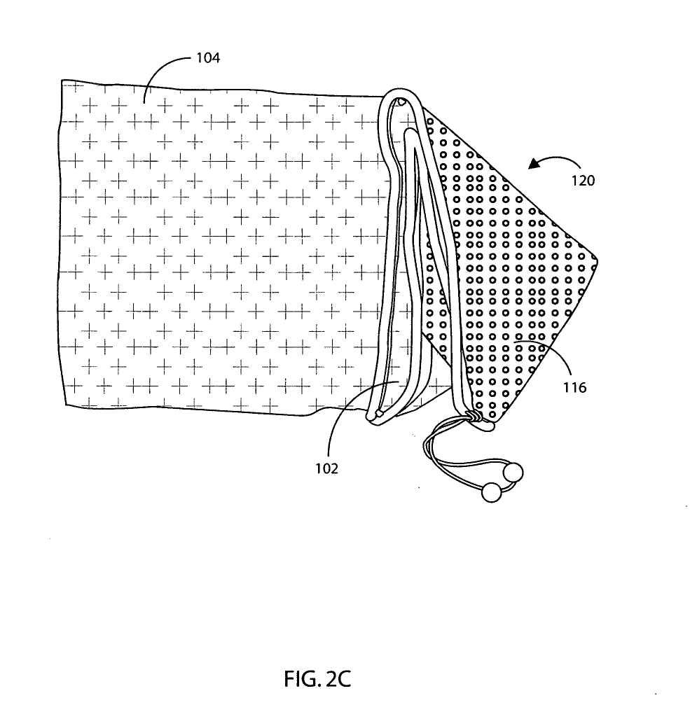

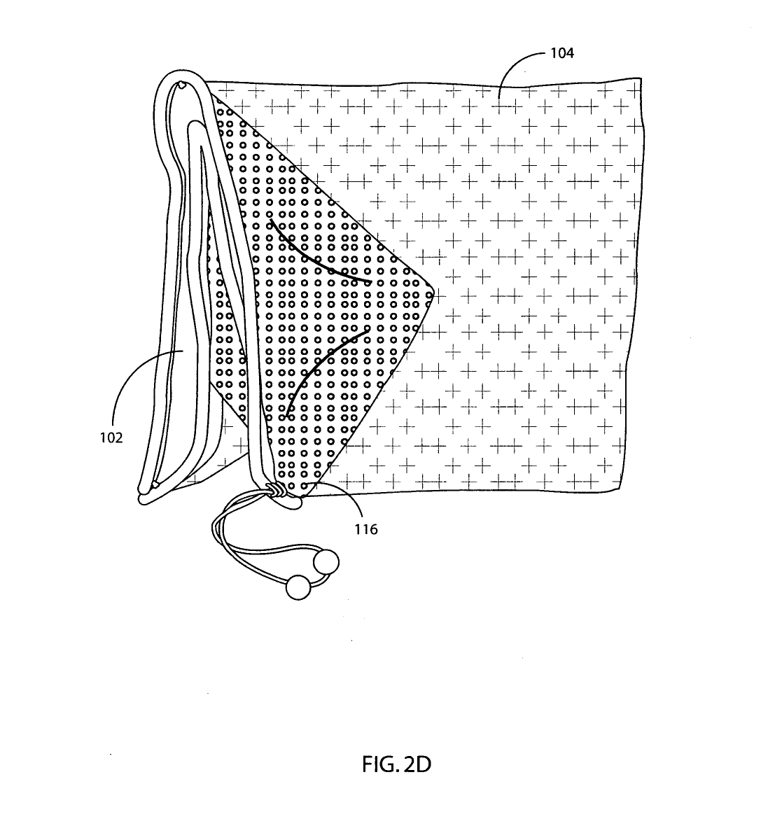

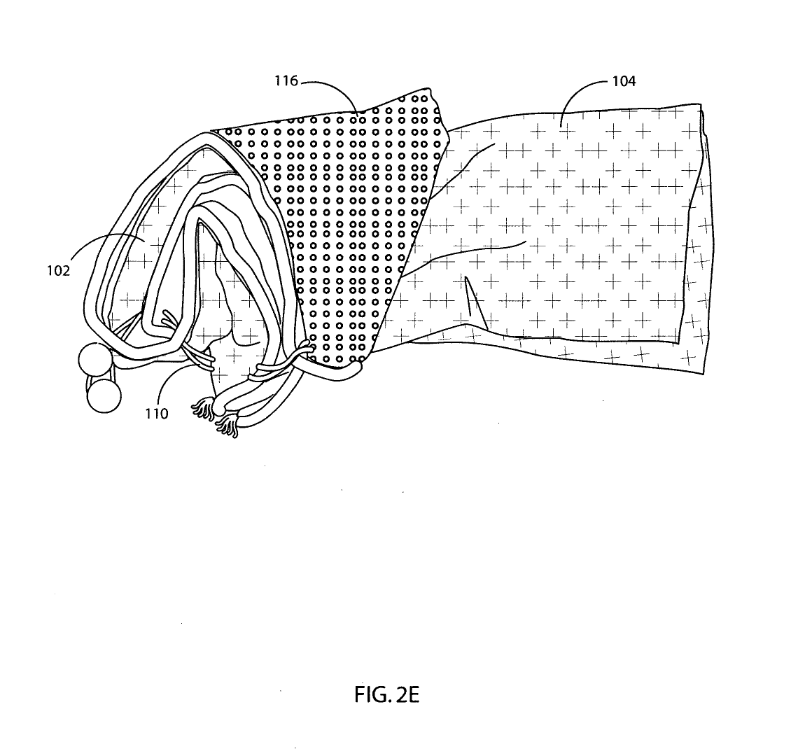

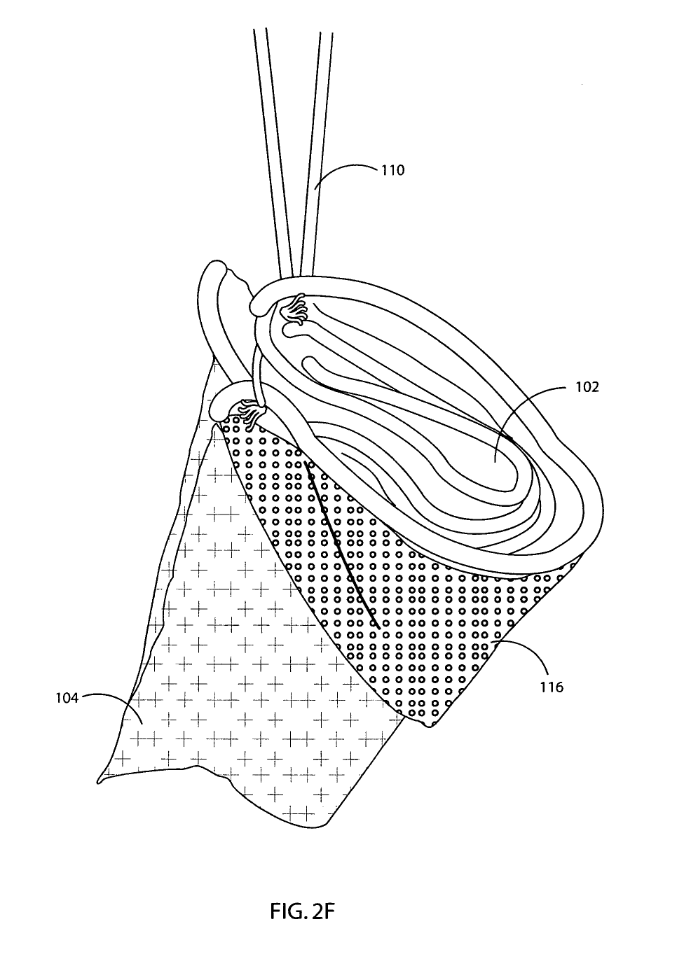

FIG. 2A-2F illustrates a golf towel 100 and the different steps involved in the double triangle type folding method of the golf towel 100. The water impervious layer 116 in the io front side of the wet section 102 helps to retain the water content and the holes 108 and thread 110 on the corners of the towel 100 assists to secure the towel 100 folded together. The wet section 102 of the towel 100 is discriminated from the dry section 104 of the towel 100 by a thick border 106 and a water impervious layer 116 attached to the wet section 112. FIG. 2A illustrates the towel 100 is first placed with the back side facing up is with the wet section 102 on top side 112 and the dry section 104 at the bottom side 114. FIG. 2B illustrates, the wet section 102 is folded diagonally inwards thereby forming a triangular shape 118 for the wet section 102 of the towel 100. The triangular section 118 is then folded frontward from the middle of it thereby further forming a triangular shaped double layered upper portion 120 as shown in FIG. 2C. Furthermore, the towel 110 is folded from the joining of the wet and dry sections 102 and 104 thereby providing the front view of the dry towel section 104 as illustrated in FIG. 2D. The micro-fiber layered wet section 102 is now on top of the dry section 104 of towel 100. Now the golf towel 100 is again folded through its center axis to form the desired shape of the triangle as in the FIG. 2E.After achieving the desired shape the golf towel 100 is then hanged up with the help of the thread 110 attached to its one corner as illustrated in the FIG. 2F.

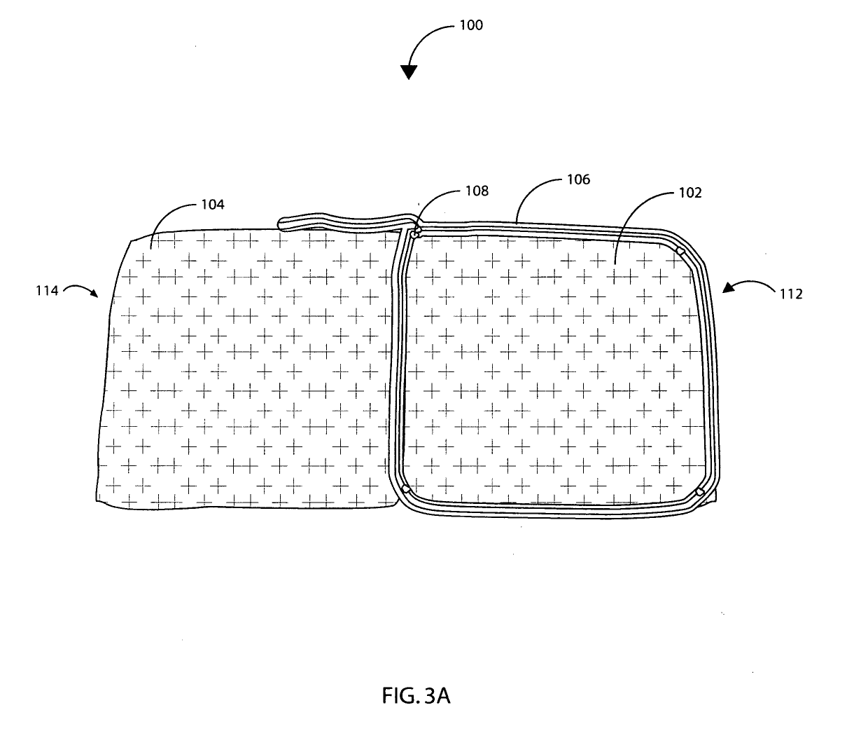

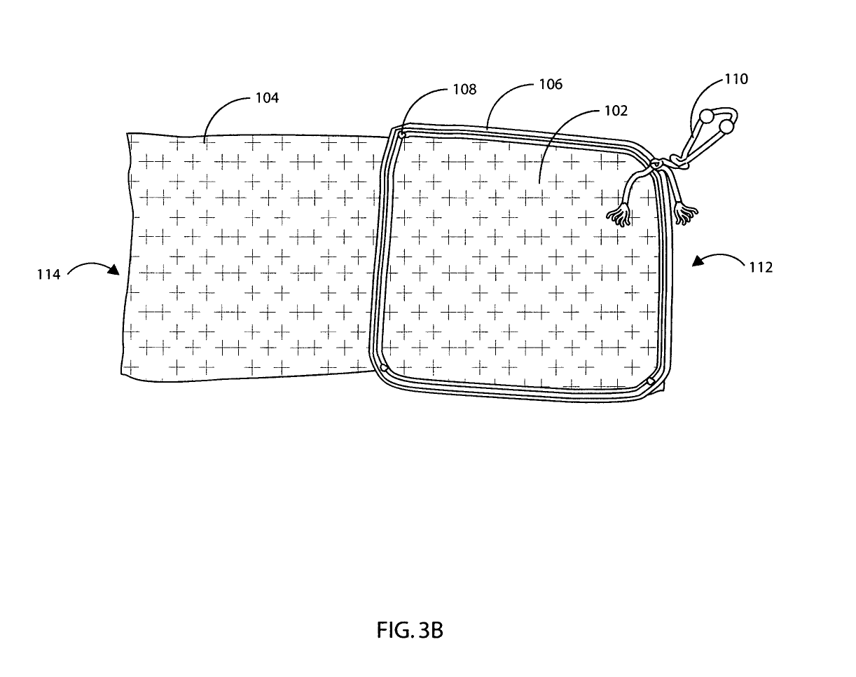

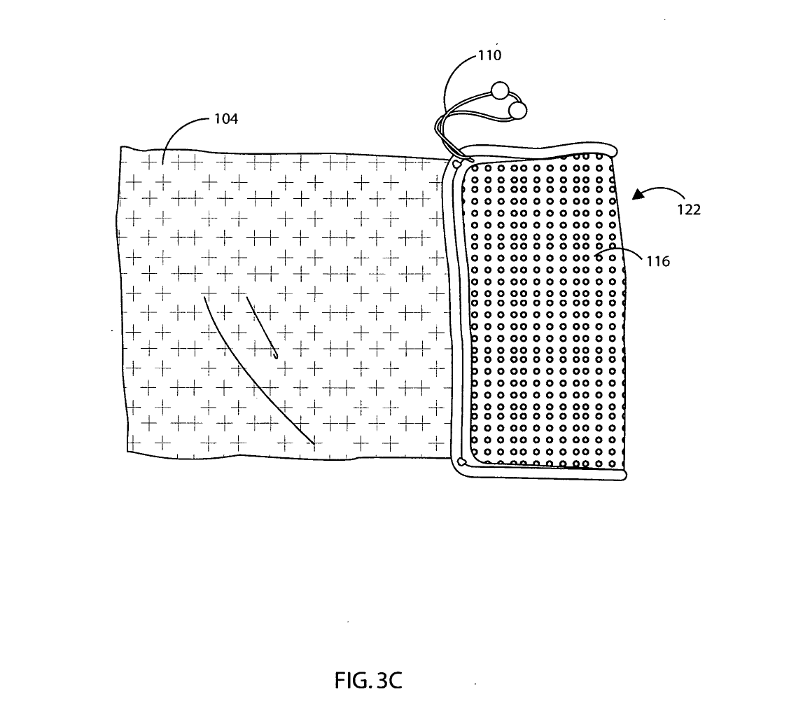

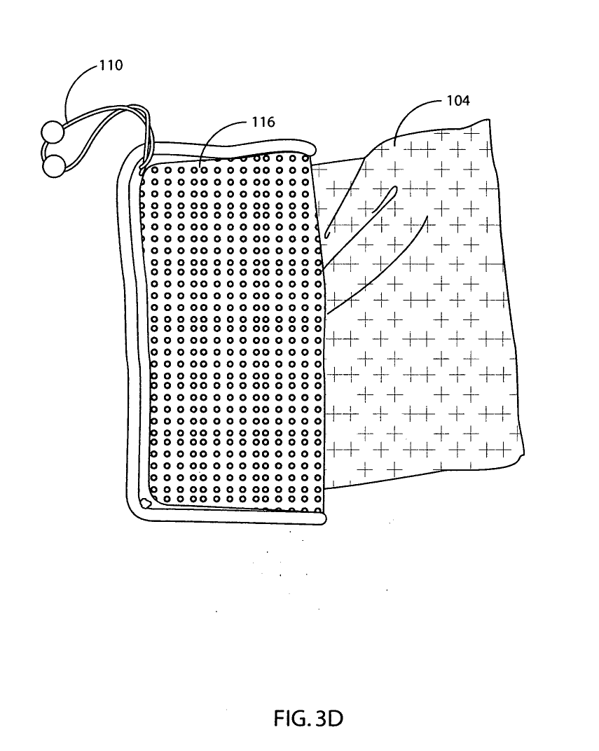

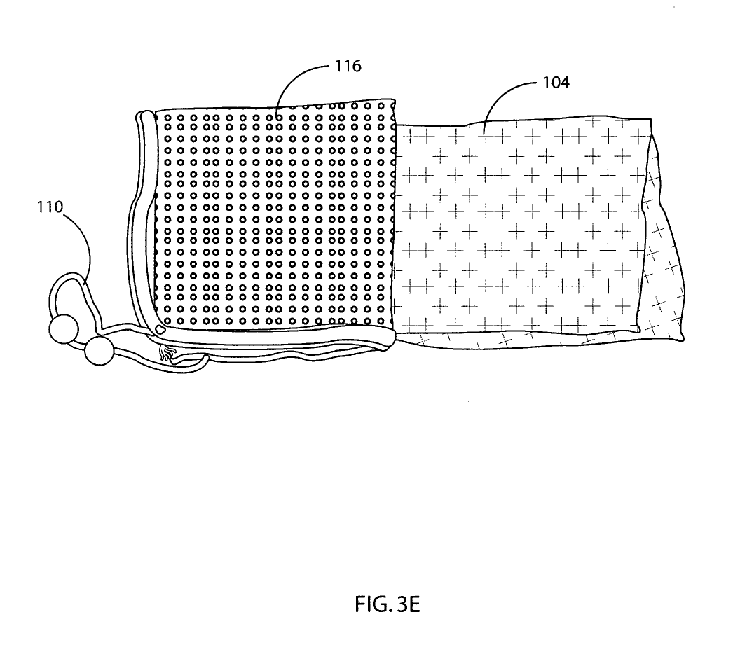

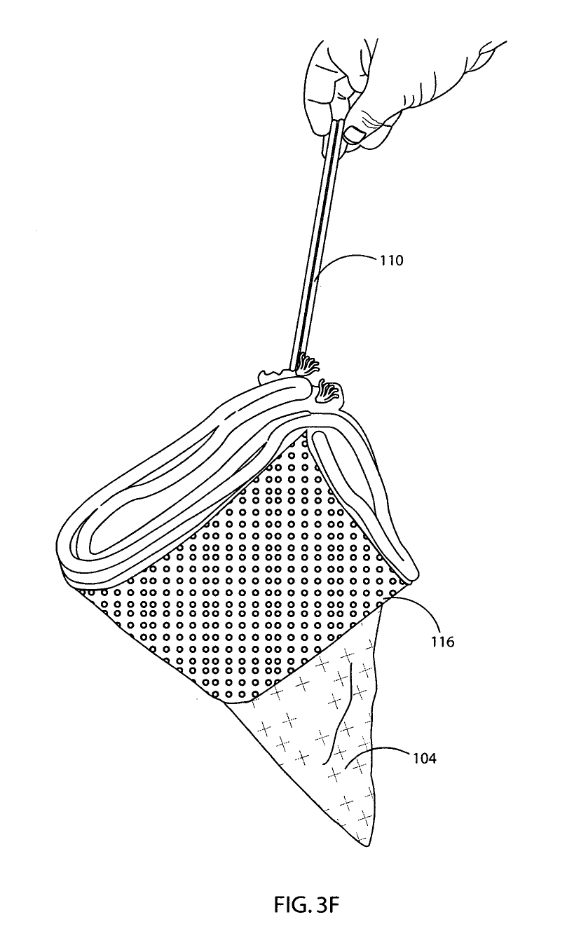

FIG. 3A-3F illustrates a golf towel 100 and different steps involved in the square type folding method of the golf towel 100. FIG. 3A illustrates the front side of the golf towel 100 without the water impervious layer 116 attached to the top portion of the golf towel 100. FIG. 3B depicts the back side of the golf towel 100 with holes 108 and thread 110 at the corners of the towel 300. The wet section 104 of the towel 100 is discriminated from the dry section 104 of the towel 100 by a thick border 106 and a water impervious layer 116 attached to the wet section 102. The golf towel 100 is first folded along the axis of top wet section 102 to form a rectangular shape 122 as shown in the FIG. 3C. Next, as in the FIG. 3D the towel 100 is folded from the joining of the dry and wet sections 104 and 102 thereby providing the front side view of the dry section 104 of the towel 100. The micro-fiber layered wet section 102 is now on top of the dry section 104 of the towel 100. Further, FIG. 3E illustrates the whole towel 100 is folded along its central axis to form desired shaped golf towel 100. After achieving the desired shape, the golf towel 100 is then hanged up with the help of the thread 110 attached to its one corner as shown in FIG. 3F.

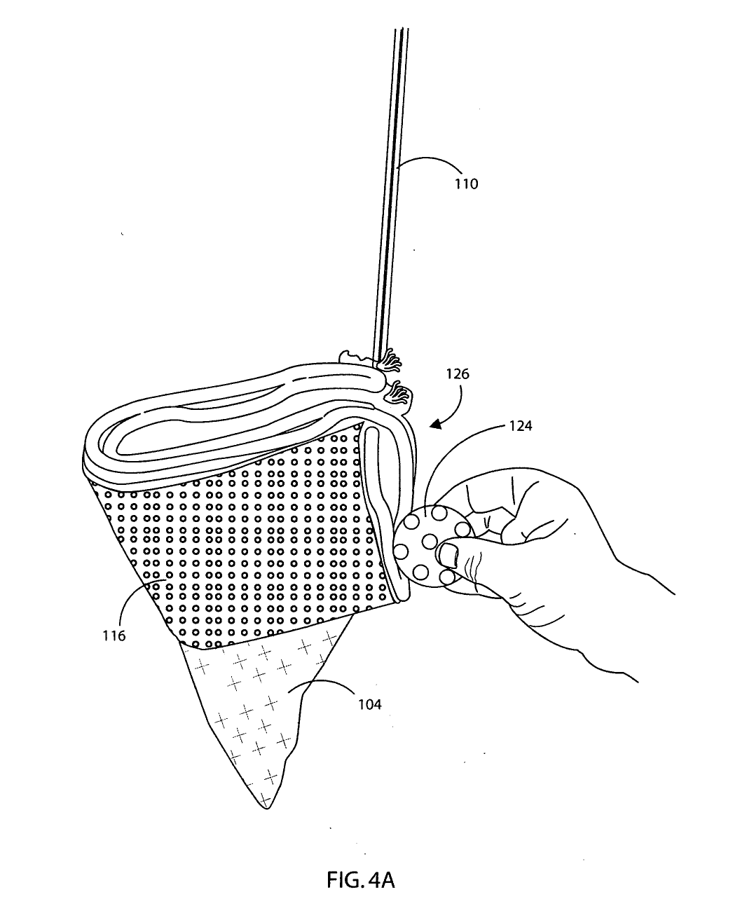

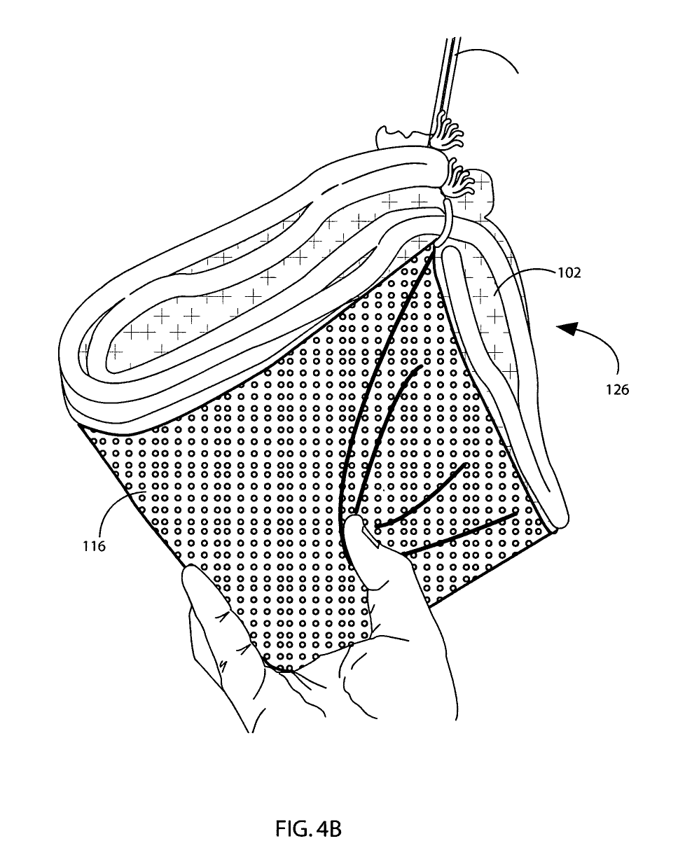

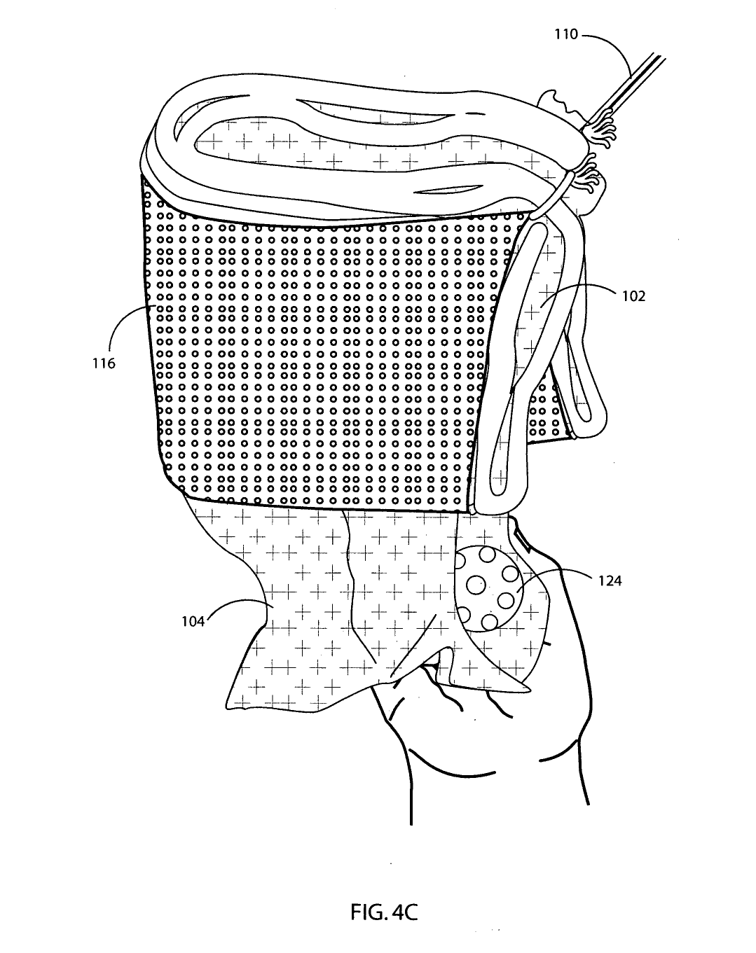

FIG. 4A-4C illustrates various steps of using the golf towel 100 for cleaning a golf ball 124. FIG. 4A illustrates the golf ball 124 first putting into a pocket like structure 126 formed in wet section 102 of the towel 100 formed after the different folding methods. The pocket like structure 126 can be formed either as a single triangle, double triangle and square type as needed. The ball 124 is further cleaned by water adhered inside the pocket like structure 126 formed by the wet section 102 of the golf towel 100 as illustrated in FIG. 4B. The ball 124 is taken out of the wet section 102 and the moisture content is removed by cleaning the ball 124 using the dry section 104 of the golf towel 100 as shown in FIG. 4C.

While a particular form of the golf towel and methods of folding has been illustrated and described, it will be apparent that various modifications can be made without departing from the spirit and scope of the invention. For example, materials, methods, structures and the like that will fall within the scope of the invention. It should be clearly understood that other golf towel and folding methods are also possible. Accordingly, it is not intended that the invention be limited, except as by the appended claims.

What is claimed is:

1. A golf towel and the method of folding the golf towel for cleaning the golf ball, the method comprising:
a) folding the golf towel by single triangle folding method;
b) folding the golf towel by double triangle folding method; and
c) folding the golf towel by square type folding method.

2. The method of claim 1 wherein the method a) of single triangle folding method comprising:
a) placing the back sides of the wet section and the dry section of the golf towel facing up;
b) folding the wet section along the diagonal of the wet section to form a triangular shaped portion;
c) folding the triangular section backwards along its centre to further form a triangular shaped section of the wet portion;
d) folding the towel from the joining of the dry and wet sections thereby the triangular shaped wet section lies on top of the dry section of the towel;
e) further folding the above section along its central axis thereby obtaining the desired single triangle shaped golf towel having a single triangle shaped pocket holding; and
f) hanging the golf towel by means of at least one hole and a thread attached to the corners of the wet portion of the towel thereby providing a means for cleaning golf balls.

3. The method of claim 1 wherein the method b) of double triangle type folding method comprising:
a) placing the back sides of the wet section and the dry section of the golf towel facing up;
b) folding the wet section along the diagonal of the wet section to form a triangular shaped portion;
c) again folding the triangular shaped section frontward along its centre to form another triangular shaped section of the wet portion;
d) folding the towel from the joining of the dry and wet sections thereby the triangular shaped wet section lies on top of the dry section of the towel;
e) further folding the triangular section along the central axis thereby obtaining the desired double triangle folding having two triangular shaped pockets to hold golf balls; and
f) hanging the golf towel with the help of the holes and a thread attached to the corners of the wet portion of the towel thereby providing a means for cleaning golf balls.

4. The method of claim 1 wherein the method c) of square type folding method comprising:
a) placing the back sides of the wet section and the dry section of the golf towel facing up;
b) folding the wet section along the central axis to form a rectangular shaped section;
c) folding the towel from the joining of the dry and wet sections thereby the rectangular shaped wet section lies on top of the front side of the dry section of the towel;
d) further folding the square section along the long central axis thereby obtaining the desired square shaped golf towel having two square shaped pockets to io hold golf balls; and
e) hanging the golf towel by means of the holes and a thread attached to the corners of the wet portion of the towel thereby providing the golf towel for cleaning golf balls.

5. The method of using the golf towel for cleaning golf balls, the method comprising:
a) placing the golf ball first into the pocket like structure of the wet section of the towel structure formed therefrom at least one of the single triangle, double triangle and the square type folding methods;
b) cleaning the ball by water absorbed inside the pocket like structure formed in the wet section of the golf towel; and
c) taking the ball out of the wet section of the towel and removing the moisture in the ball by wiping the ball the dry section of the golf towel.
